(19) United States
(12) Patent Application Publication
(10) Pub. No.: US 2013/0328491 A1
(43) Pub. Date: Dec. 12, 2013

(54) ILLUMINATION APPARATUS AND POWER SUPPLY VOLTAGE MANAGEMENT METHOD THEREOF

(71) Applicants: Tao Hung CHOU, Taipei (TW); Chun Teng Tseng, Sanwan Township (TW); Pin Syuan Li, Hsinchu (TW)

(72) Inventors: Tao Hung CHOU, Taipei (TW); Chun Teng Tseng, Sanwan Township (TW); Pin Syuan Li, Hsinchu (TW)

(73) Assignee: POLYTRONICS TECHNOLOGY CORP., Hsinchu (TW)

(21) Appl. No.: 13/869,457

(22) Filed: Apr. 24, 2013

(30) Foreign Application Priority Data
Jun. 7, 2012 (TW) 101120601

(51) Int. Cl. H05B 37/02

(52) U.S. Cl. CPC H05B 37/02
USPC 315/191

(57) ABSTRACT

An illumination apparatus includes a rectifier, a linear regulator, a lighting unit and a temperature sensing control circuit. The rectifier is connected to an AC supply voltage. The regulator is electrically connected to the rectifier and is adaptive to a first voltage. The lighting apparatus and the regulator form a circuit coupled to the AC power supply. The lighting unit has first and second loads having respective first and second lighting components adaptive to the first voltage. The control circuit can effectively sense the temperature of the regulator and thereby determines whether the first and second load are connected in series or in parallel. If the supply voltage is the first voltage, the first and second load is connected in parallel. If the supply voltage is a second voltage greater than the first voltage, the temperature sensing control circuit switches the first and second load to be connected in series.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present application relates to an illumination apparatus and power supply voltage management method thereof.

2. Description of Related Art Including Information Disclosed Under 37 CFR1.97 and 37CFR 1.98.

A switch regulator operates between on and off states and deliver stable output voltage through adjusting the ratio of “on” period to “off” period, so as to readily implement the changes of different voltages and polarities. It can be employed for the applications not. suitable for a linear regulator. Well-designed switch regulators acquire higher conversion efficiency, but the circuitry is relatively complex and switch noises may exist.

In general, a linear regulator operates in linear state and adjusts its internal resistance in light of the load variance to output stable voltage. It is simple and has low noise but is used for voltage drop only. The conversion efficiency can refer to the ratio of output voltage to input voltage, and the linear regulator is usually used for small voltage difference and low power circumstances. The liner regulator is not adaptive to power supply systems of two different voltages. For instance, it cannot perform voltage switch between 110 and 220 VAC or between 120 and 240 VAC directly.

Nowadays, traditional illuminations are being replaced with LED illuminations gradually. However, the power supply voltages for countries worldwide are different, and there may have different power supply voltages even in a building. Therefore, if LED illumination apparatus is connected to an unexpected power supply voltage inadvertently, it will be burned out. From manufacturing point of view, although the illumination apparatus can be associated with different linear regulators according to various, voltages, this approach will increase manufacture cost.

### BRIEF SUMMARY OF THE INVENTION

The present application relates to an illumination apparatus and the power supply voltage management method thereof, and especially the illumination apparatus and power supply voltage management method thereof adaptive to different power supply voltages. In accordance with the present application, damage to the Illumination apparatus can he avoided if it is connected to a wrong power supply voltage, and illumination apparatuses can be of the same specification for mass production to decrease manufacturing and overhead expenses.

In accordance with an embodiment of the present application, an illumination apparatus comprises a rectifier, a linear regulator, a lighting unit and a temperature sensing control circuit. The rectifier is connected to an alternating current (AC) power supply of a supply voltage for AC-to-DC conversion. The linear regulator is electrically connected to the rectifier and is adaptive to a first voltage, e.g., 120V. The lighting unit is electrically coupled to the linear regulator at an end and is electrically coupled to the rectifier at another end. The lighting unit comprises a first load and a second bad. The first load comprises a first lighting component and the second load comprises a second lighting component, the first and second lighting components being adaptive to the first voltage. The temperature sensing control circuit is adjacent to the linear regulator to effectively sense the temperature of the linear regulator, thereby determining whether the first load and the second load are connected in series or in parallel.

If the supply voltage is the first voltage, the first load and the second load are connected in parallel. When the supply voltage is a second voltage, e.g., 240V, greater than the first voltage, the temperature sensing control circuit will sense a temperature of the linear regulator over a threshold value and then switch the first load and the second load to be connected in series.

In an embodiment, the temperature sensing control circuit comprises a thermistor such as a positive temperature coefficient (PTC) device configured to sense the temperature of the linear regulator. If the power supply voltage is the first voltage, the PTC device does not trip. If the power supply voltage is the second voltage, the linear regulator heats up, and the PTC device will trip by sensing the temperature of the linear regulator.

In an embodiment, the temperature sensing control circuit further comprises a latch, which is configured to sustain the state of series connection after the first load and the second load are switched to be connected in series.

In accordance with another embodiment of the present application, an illumination apparatus comprises an AC power supply of a supply voltage and at least one lighting unit. The lighting unit is connected to the power supply to form a circuit loop. The lighting unit comprises a pair of lighting modules each containing a linear regulator, a lighting component and a temperature sensing control circuit. The linear regulator is adaptive to a first voltage, e.g., 120V. The light component is connected to the linear regulator, and voltage difference across the lighting component is equal to the first voltage. The temperature sensing control circuit is adjacent to the linear regulator and is capable of sensing the temperature of the linear regulator effectively.

If the supply voltage is the first voltage, the lighting components of the pair of the lighting modules are connected in parallel. If the supply voltage is a second voltage, e.g., 240V, greater than the first voltage, at least one of the temperature sensing control circuit senses the temperature of the linear regulator, and accordingly the lighting components are switched to be connected in series.

In accordance with yet another embodiment of the present application, if the illumination apparatus is connected to the power supply of the second voltage such as 240V, the power supply voltage management method, of the Illumination apparatus can be summarized into the following: (1) providing the aforesaid Illumination apparatus of which the first lighting component and the second lighting component are connected in parallel; (2) connecting the illumination apparatus to the power supply of a second voltage greater than the first voltage; (3) increasing the temperature of the linear regulator when the second voltage is applied thereto; and (4) switching the first and second lighting components to be in series connection when the temperature sensing control circuit senses that the temperature of the linear regulator reaches or exceeds a threshold value.

The illumination apparatus has a simple circuit and is cost-effective. Therefore, it is an effective solution for the applications utilizing different power supply voltages.

### BRIEF DESCRIPTION OF THE SEVERAL VIEWS OF THE DRAWINGS

The present application will be described according to the appended drawings in which:

FIGS. 1 and 2 show an illumination apparatus in accordance with a first embodiment of the present application;

FIG. 3 shows a power supply voltage management method of the illumination apparatus in accordance with the present application;

FIGS. 4 and 5 show an illumination apparatus in accordance with a second embodiment of the present application;

FIG. 6 shows an illumination apparatus in accordance with a third embodiment of the present application; and

FIGS. 7 to 9 show a simulation circuit and the simulation result of the present application.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

There are various power supply systems using different voltages in countries worldwide. Even in the same country, different voltages may be used also. For example, in some countries 120V AC is used for general appliances, and 240V AC is used for air conditioners. If a wrong voltage is applied to a lamp, the brightness may be insufficient or the lamp may be burned out. The present application provides simple and effective solution to resolve the problems.

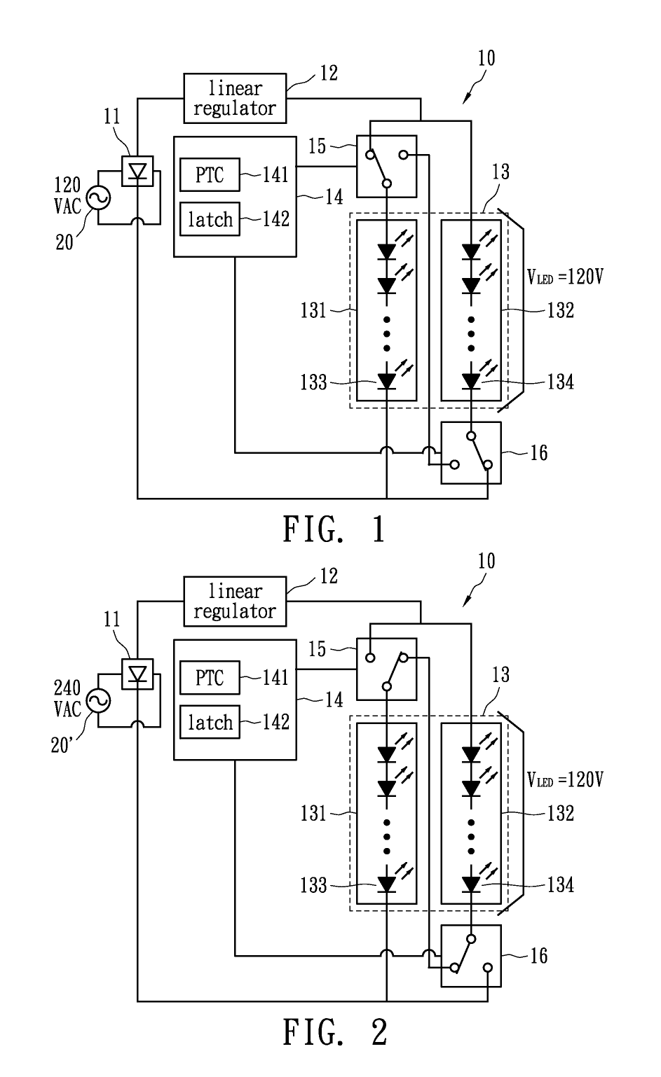

FIG. 1 and FIG. 2 show an illumination apparatus in accordance with a first embodiment of the present application. An illumination apparatus 10 comprises a rectifier 11, a linear regulator 12, alighting unit 13 and a temperature sensing control circuit 14. The rectifier 11 is coupled to a power supply 20 of 120VAC for AC-to-DC conversion. The linear regulator 12 is electrically connected to the rectifier 11 and is adaptive to a first voltage such as 120V. The illumination apparatus 13 is coupled to the linear regulator 12 at an end and is coupled to the rectifier 11 at another end. The lighting unit 13 and the linear regulator 12 are coupled to the power supply 20 to form a circuit loop. The lighting unit 13 comprises a first load 131 and a second load 132. In an embodiment, the first load 131 contains a first lighting component 133 adaptive to the first voltage, and the second toad 132 contains a second lighting component 134. It can be seen that the voltage difference across the first lighting component 133 is the first voltage, e.g., 120V, and the voltage difference across the second lighting component 134 is the first voltage also. In an embodiment, the first and second lighting components 133 and 134 may contain one or more LED lighting device., such as the combination of plural LED chips shown in FIGS. 1 and 2.

In an embodiment, the temperature sensing control circuit 14 comprises a themistor 141 such as a PTC device. The temperature sensing control circuit 14 is adjacent to the linear regulator 12; more specifically it is within an effective distance capable of sensing the temperature of the linear regulator 12. The effective distance is equal to or less than 5 mm, or less than 3 mm or 2 mm in particular. The thermistor 141 may be associated with a thermal conductive material to readily sense the temperature variation of the linear regulator 12 by heat conduction. According to the temperature of the linear regulator 12, the temperature sensing control circuit 14 determines whether the first load 131 and the second load 132 are in a series or parallel connection.

In an embodiment, a switch 15 is between the linear regulator 12 and an end of the first load 131, and an end of the second load 132 is connected to the linear regulator 12. Another end of the first load 131 is coupled to the rectifier 11, and a switch 16 is between another end of the second load 132 and the rectifier 11.

When the illumination apparatus 10 has yet to connect to a power supply, the first load 131 and the second load 132 are connected in parallel. In FIG. 1, if the rectifier 11 is connected to the power supply 20 of a first voltage, e.g., 120V, the linear regulator 12 will not generate heat abnormally because it is adaptive to the first voltage. The state of the first load 131 and the second load 132 in series connection is sustained. The voltage difference across the first lighting component 133 is the first voltage such as 120V, and the voltage difference across the second lighting component 134 is the first voltage also.

If the rectifier 11 is connected to the power supply 20 of a second voltage, e.g., 240V, which is larger than the first voltage, the double voltage will induce abrupt increase of the current flowing through the linear regulator 12. As a consequence, the temperature of the linear regulator 12 increases significantly, and may be larger than 100° C. If the thermistor 141 of the temperature sensing control circuit 14 senses a temperature of the linear regulator 12 larger than a threshold value, e.g., the trip temperature of the thermistor 141, the switches 15 and 16 will be switched to make the first load 131 and the second load 132 be connected in series, as shown in FIG. 2.

If the first load 131 is the same as the second load 132, or the first lighting component 133 is the same as the second lighting component 13, the entire resistance thereof is doubled because the first load 131 and the second load 132 change to be connected in series. It should be noted that the second voltage (240V) is two times the first voltage (120V); however the resistance thereof is doubled as well, so that the current going through the first and second loads 131 and 132 will be kept the same as that in parallel connection. Accordingly, the lighting component 133 and 134 will emit equivalent brightness.

After the first load 131 and the second load 132 are switched to be in series connection, the linear regulator 12 will return to normal temperature and the temperature of the thermistor 141 will decrease to lower than trip temperature. The series connection of the first and second loads 131 and 132 is sustained. In an embodiment, the temperature sensing control circuit 14 contains a latch 142 to sustain the series connection state of the first and second loads 131 and 132.

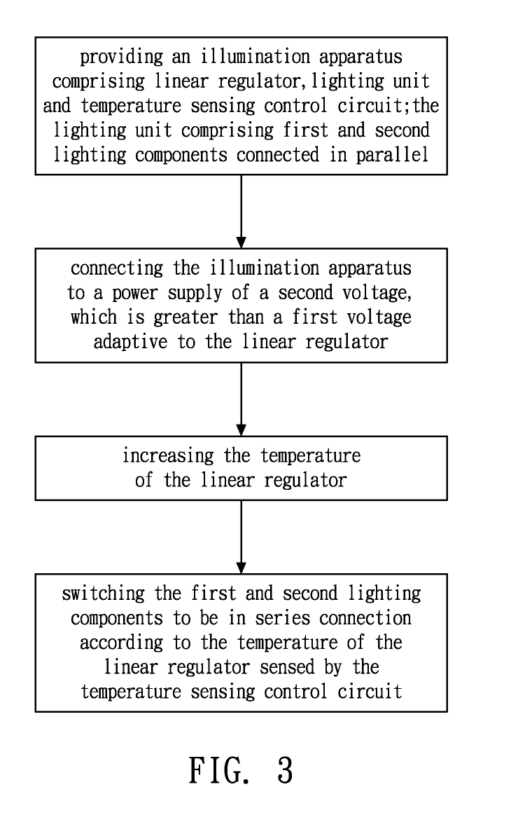

Referring to FIG. 3, the aforesaid illumination apparatus actually perform a power supply voltage management method, especially for the applications involving different voltages, which can be summarized in the following: (1) providing the illumination apparatus of which a first lighting component and a second lighting component are in parallel connection, the linear regulator, the first lighting component and the second lighting component being adaptive to a first voltage; (2) connecting the illumination apparatus to the power supply of a second voltage, the second voltage being greater than the first voltage; (3) increasing a temperature of the linear regulator by applying the second voltage thereto; and (4) switching the first lighting component and the second lighting component to be in series connection when the temperature sensing control circuit senses that a temperature of the linear regulator reaches a threshold value.

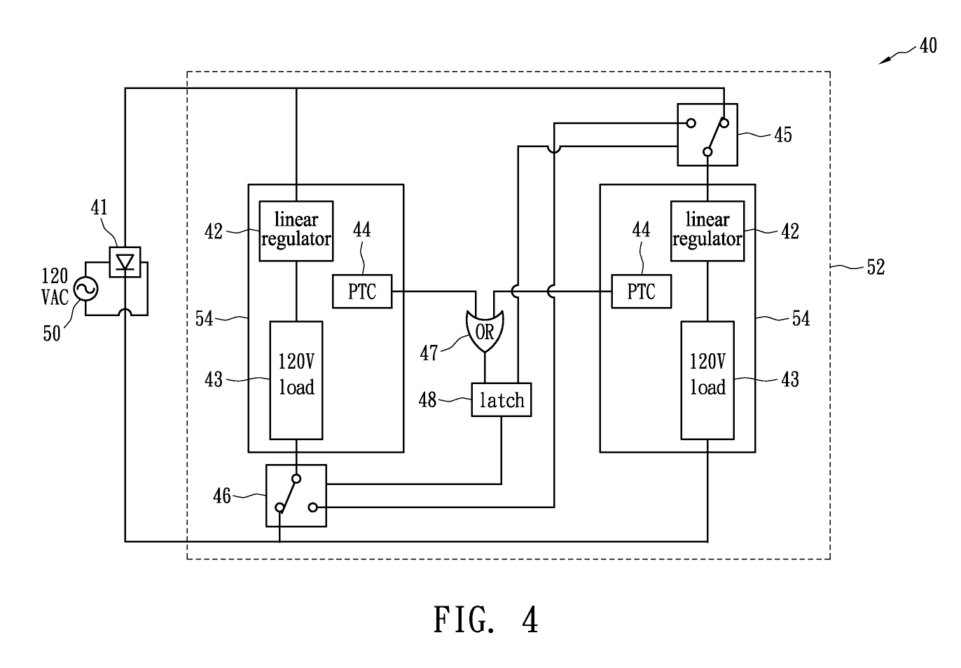

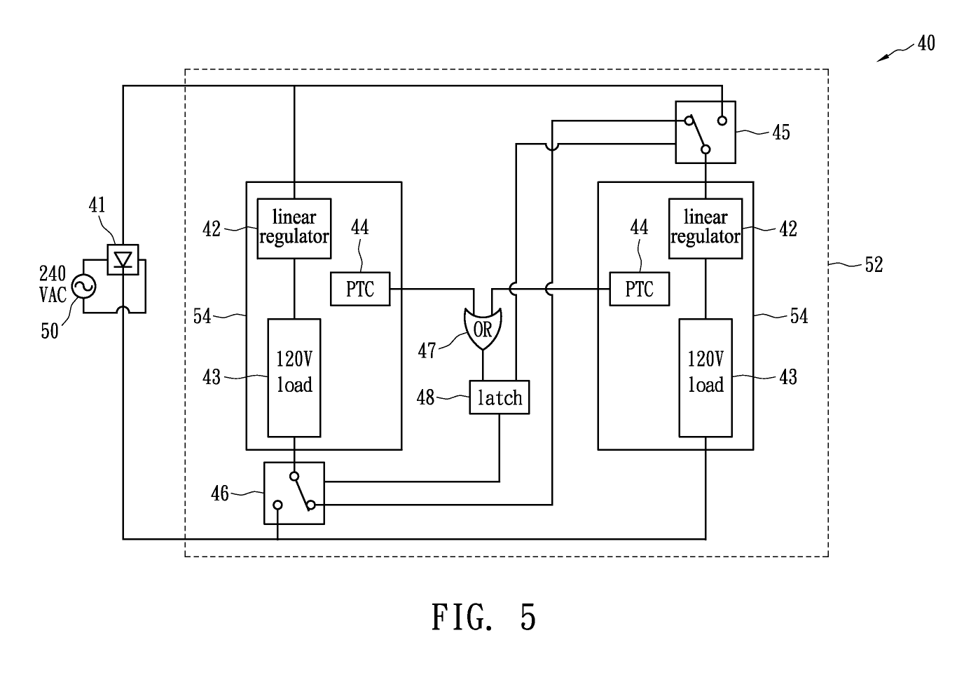

FIG. 4 and FIG. 5 show an illumination apparatus in accordance with a second embodiment of the present application. This embodiment uses modular design to facilitate mass production and the convenience of assembly.

An illumination apparatus 40 comprises a power supply 50, a rectifier 41 and a lighting unit 52. The lighting unit 52 is coupled to the power supply 50 through the rectifier 41 to form a circuit loop. The lighting unit 52 comprises a pair of lighting modules 54, and each of the lighting modules 54 comprises a linear regulator 42, a load 43 and a temperature sensing control circuit 44. Like the first embodiment, the linear regulator 12 is adaptive to the first voltage (120V), and the load 43 may be LED chips. The load 43 is coupled to the linear regulator 42, and the voltage difference across the load 43 is the first voltage 120V. The temperature sensing control circuit 44 is adjacent to the linear regulator 42 so as to sense the temperature of the linear regulator 42 effectively.

The lighting unit 52 further comprises an OR gate 47. The input end of the OR gate 47 is coupled to the temperature sensing control circuit 44 of each lighting module 54, and the output end of the OR gate 47 sends signals to the first switch 45 and the second switch 46 to change the loads 43 of the pair of the lighting modules 54 from parallel connection to series connection.

Referring to FIG. 4, if the voltage of the power supply is a first voltage, e.g., 120V, the loads 43 of the pair of the lighting modules 54 are in series connection. Referring to FIG. 5, if the power supply 50 provides a second voltage, e.g., 240V, which is greater than the first voltage, at least one temperature sensing control circuit 44 of the lighting modules 54 will sense the temperature of the linear regulator 42 and accordingly switch the loads 43 of the lighting module 54 to be in series connection. In other words, if the temperature sensing control circuit 44 of any lighting module 54 senses abnormal temperature of the corresponding linear regulator 42 larger than a threshold value, the loads 43 of the lighting modules 54 are switched to be connected in series.

In an embodiment, the temperature sensing control circuit 44 contains a PTC device. When the voltage of the power supply 50 is the first voltage, e.g., 120V, the PTC device does not trip. When the voltage of the power supply 50 is the second voltage, the linear regulator 42 heats up and the PTC device will trip as it effectively sensed an abnormal high temperature of the linear regulator 42.

In an embodiment, the lighting unit 52 further comprises a latch 48 coupled to the output end of the OR gate 47. The latch 48 is configured to sustain the series connection state after switching.

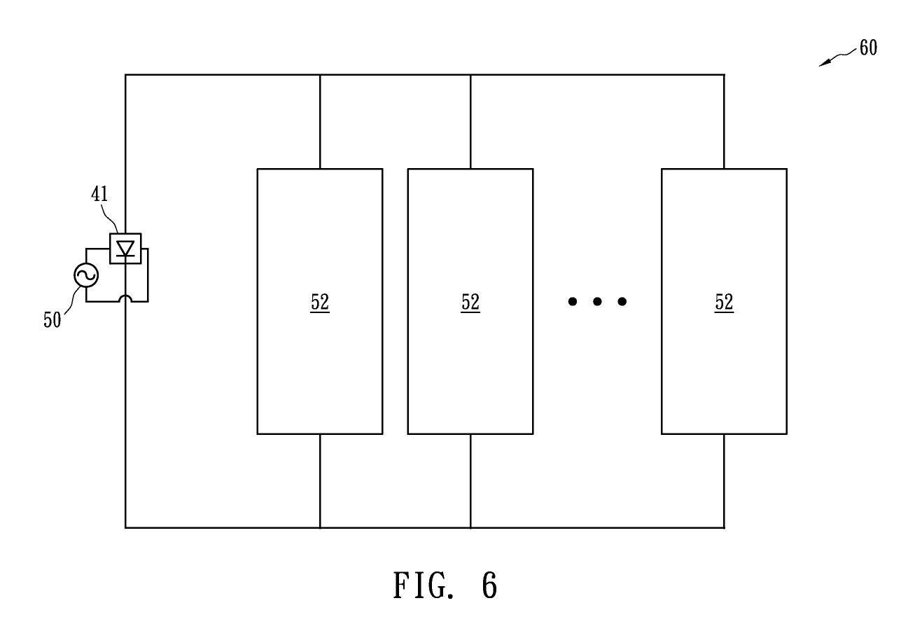

FIG. 6 shows an illumination apparatus in accordance with a third embodiment of the present application. An illumination apparatus 60 is an extension to the illumination apparatus 40 mentioned above. The illumination apparatus 60 comprises a plurality of lighting units 52, and the plurality of lighting units 52 are connected to the power supply 50 in parallel. By doing so, the illumination apparatus 60 can contain more lighting loads 43, so as to provide large-area light, source or other variations.

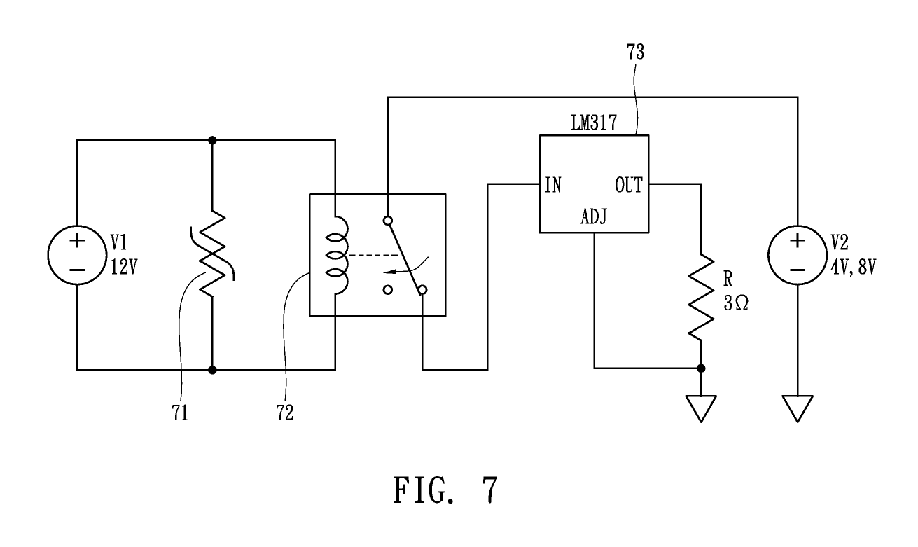

To verify the switching in response to sensing the temperature of the linear regulator by the thermistor, a simulation test is conducted below. Referring to FIG. 7, a PTC device 71 and a relay 72 are coupled to V1 (12V) in parallel, and a three-terminal adjustable regulator 73 (LM317) simulating the linear regulator is in connection with a resistor R of 3Ω and is coupled to V2. In this experiment, V2 is 4V or 8V. A PTC device 71 employs SMD 1210P175SLR-V produced by Polytronics Technology Corporation. The PTC device 71 and the regulator 73 are placed on the upper and lower surfaces of an aluminum substrate, respectively, and the PTC device 71 is adjacent to the regulator 73 to instantly and effectively sense the temperature variation of the regulator 73. The distance between the PTC device 71 and the regulator 73 are preferably less than 3 cm, or 2 cm in particular. A thermocouple is used to measure the temperature of the aluminum substrate. Because the heat of the PTC device 71 can be transferred to the aluminum substrate rapidly, their temperature variations will be consistent. Therefore, the temperature measured by the thermocouple indicates the temperature tendency of the PTC device 71.

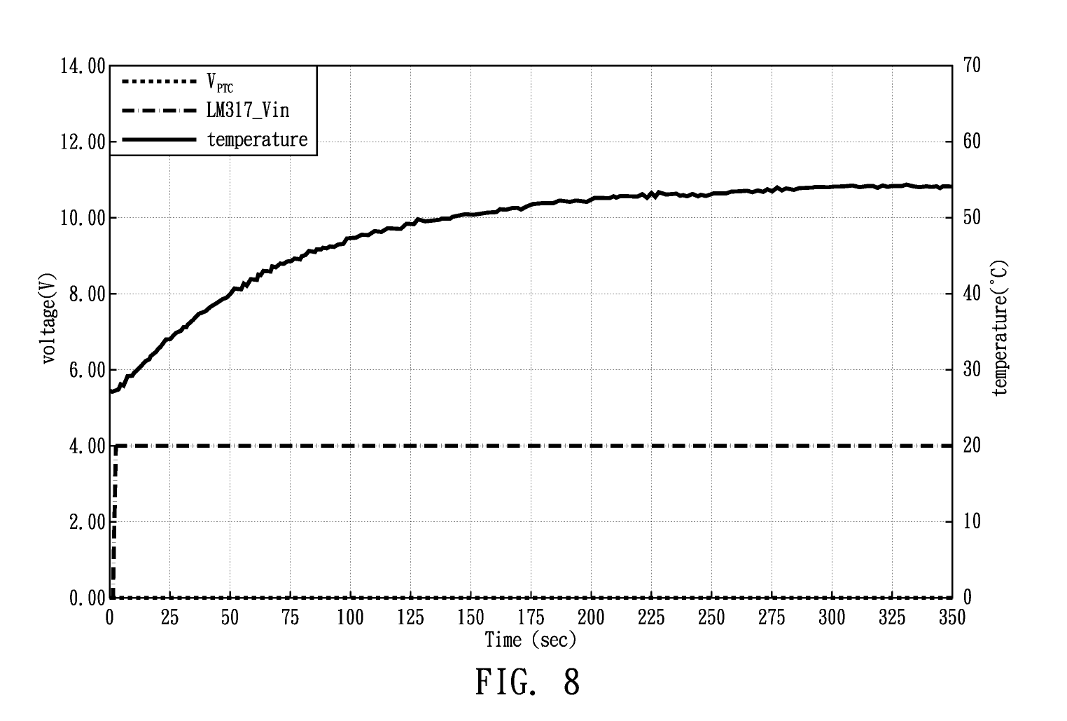

In the simulation of low voltage, in which the regulator 73 has a voltage difference Vin-Vout of 4V, a voltage 12V and current 0.1A are applied to the PTC device 71. Initially, the relay 72 is in normal closed state as shown in FIG. 7, and current flows through the PTC device 71. The PTC device 71 gradually heats up to approximately 53° C. after 200 seconds and then the incremental rate of the temperature significantly decreases. After 300 seconds, the temperature does not increase further. Because the temperature of the PTC device 71 does not exceed the trip temperature thereof current still flows through the PTC device 71 and the relay 72 has yet to be enabled. Accordingly, the relay 72 sustains in normal closed state, and the input voltage Vin of the regulator 73 is still 4V, as shown in FIG. 8.

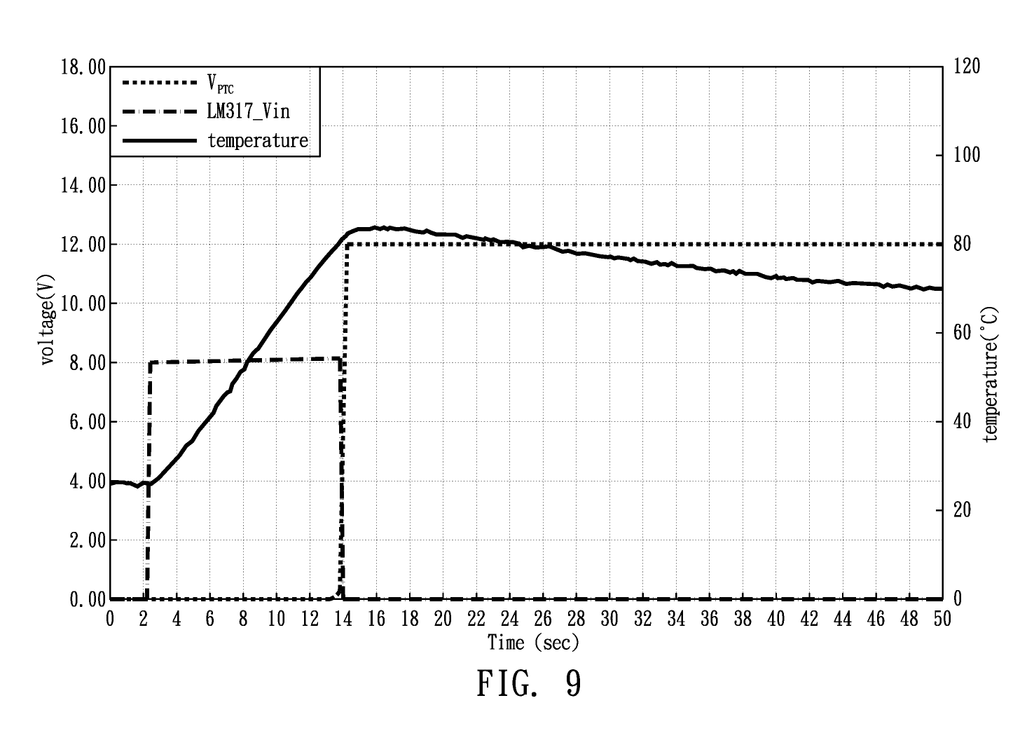

Referring to FIG. 7 and FIG. 9, the regulator 73 has a voltage difference Vin-Vout of 8V, which is double of 4V. Similarly, a voltage of 12V and a current of 0.1 A are applied to the PTC device 71. When 8V is applied thereto, the PTC device 71 heats up significantly, and the temperature of the PTC device 71 (or the temperature of the aluminum substrate) increases to 82° C. after around 14 seconds. As a consequence, the PTC device 71 trips and block the current flowing therethrough, and therefore the current changes to go through the coil of the relay 72. Then the relay 72 is open caused by electromagnetic effect of the coil, and as a result the input path of the regulator LM317 becomes open, i.e., Vin=0. At the same time, the voltage across the PTC device 71 increases to 12V.

In view of the above, if Vin-Vout for the regulator 73 is 4V, the temperature of the regulator 73 sensed by the PTC device 71 does not reach or exceed the trip temperature, the relay 72 is not enabled. When Vin-Vout for the regulator 73 is 8V, the temperature of the regulator 73 sensed by the PTC device 71 rapidly increases to the trip temperature, thereby enabling the relay 72. The relay 72 simulates the temperature sensing control circuit 14 and 44 and can switch its state in response to the trip event of the PTC device 71. Accordingly, the people having ordinary knowledge in this field can produce adequate designs for switching the connection state for the loads in response to different power supply voltage 100-120V or 200-240V. After the loads changes to be connected in series, the current flowing through the linear regulator reduces by half, thereby preventing the regulator from damage caused by successive increase of temperature.

The PTC device of high or low trip temperature can be chosen according to different conditions or needs to acquire adequate trip time. As the description for FIGS. 1 and 2, the current flowing through the loads is the same regardless of series or parallel connection, thereby providing equivalent brightness. Therefore, the switching time is cot restricted as long as it can prevent the linear regulator from being burned out.

The present application provides an effective solution for an illumination apparatus which may be connected to different power supply voltages, such as 100-120V AC and 200-240VAC. Even if the illumination apparatus is coupled to an unexpected power supply voltage, the illumination apparatus does not burn out and can emit equivalent brightness. Therefore, the illumination apparatus can be of the same specification for mass production, and therefore the manufacturing and overhead expenses can be reduced.

The above-described embodiments of the present invention are intended to be illustrative only. Numerous alternative embodiments may be devised by persons skilled in the art without departing from the scope of the following claims.

We claim:

1. An illumination apparatus, comprising:
a rectifier configured to connect to an AC power supply of a supply voltage for AC-to-DC conversion;
a linear regulator coupled to the rectifier and adaptive to a first voltage;
a lighting unit associated with the linear regulator to form a circuit loop coupled to the power supply, the lighting unit comprising:
a first lighting component adaptive to the first voltage; and
a second lighting component adaptive to the first voltage; and
a temperature sensing control circuit capable of effectively sensing a temperature of the linear regulator, thereby determining whether the first lighting component and the second lighting component are in a series or parallel connection;
wherein the first lighting component and the second lighting component are in parallel connection if the supply voltage is the first voltage, and the first lighting component and the second lighting component switch to be in series connection if the supply voltage is a second voltage which is greater than the first voltage.

2. The illumination apparatus of claim 1, wherein the temperature sensing control circuit switches the first lighting component and the second lighting component to be in series connection when it senses that the temperature of the linear regulator reaches a threshold value.

3. The illumination apparatus of claim 2, wherein the temperature sensing control circuit comprises a PTC device adjacent to the linear regulator to sense the temperature of the linear regulator, and the threshold value is a temperature at which the PTC device trips.

4. The illumination apparatus of claim 3, wherein a distance between the PTC device and the linear regulator is less than 3 cm.

5. The illumination apparatus of claim 3, wherein the PTC device does not trip if the supply voltage is the first voltage, and the PTC device trips if the supply voltage is the second voltage.

6. The illumination apparatus of claim 5, wherein the temperature sensing control circuit switches the first load and the second load to be in series connection when the PTC device trips.

7. The illumination apparatus of claim 1, wherein the first lighting component is the same as the second lighting component and the second voltage is two times the first voltage.

8. The illumination apparatus of claim 1, wherein the temperature sensing control circuit further comprises a latch which is configured to sustain the series connection when the first load and the second load switch to be in a series connection.

9. An illumination apparatus, comprising:
an AC power supply of a supply voltage; and
at least one lighting unit coupled to the AC power supply to form a circuit loop, the lighting unit comprising:
a pair of lighting modules each comprising:
a linear regulator adaptive to a first voltage;
a lighting component coupled to the linear regulator, a voltage difference across the lighting component being the first voltage; and
a temperature sensing control circuit adjacent to the linear regulator and capable of effectively sensing a temperature of the linear regulator;
wherein the lighting components of the pair of lighting modules are in parallel connection if the supply voltage is the first voltage, and the lighting components of the pair of lighting modules switch to be in series connection if the supply voltage is a second voltage which is greater than the first voltage.

10. The illumination apparatus of claim 9, wherein the temperature sensing control circuit switches the lighting components of the pair of lighting modules to be in series connection when it senses that the temperature of the linear regulator reaches a threshold value.

11. The illumination apparatus of claim 9, wherein the temperature sensing control circuit comprises a PTC device to sense the temperature of the linear regulator, the PTC device does not trip if the supply voltage is the first voltage, and the PTC device trips if the supply voltage is the second voltage.

12. The illumination apparatus of claim 9, wherein the lighting unit further comprises an OR gate of which an input end coupled to the temperature sensing control circuits of the pair of lighting modules and an output end sends a signal to switch the lighting components to be in parallel connection.

13. The illumination apparatus of claim 12, wherein the lighting unit further comprises a latch connected to the output end of the OR gate to sustain the series connection after the light components switch to be in series connection.

14. The illumination apparatus of claim 9, wherein a plurality of lighting units are coupled to the AC power supply in parallel.

15. The illumination apparatus of claim 9, wherein the second voltage is two times the first voltage.

16. A power supply voltage management method for an illumination apparatus, comprising:
providing an illumination apparatus, the illumination apparatus comprising a linear regulator, a lighting unit and a temperature sensing control circuit, the linear regulator and the lighting unit forming a circuit loop coupled to a power supply, the lighting apparatus comprising a first lighting component and a second lighting component in parallel connection, the linear regulator, the first lighting component and the second lighting component being adaptive to a first voltage;
connecting the illumination apparatus to the power supply, wherein the power supply provides a second voltage greater than the first voltage;
increasing a temperature of the linear regulator by applying the second voltage thereto; and
switching the first lighting component and the second lighting component to be in series connection according to a temperature of the linear regulator sensed by the temperature sensing control circuit.

17. The power supply voltage management method of claim 16, wherein the temperature sensing control circuit switches the first and second lighting components to be in series connection when it senses that the temperature of the linear regulator reaches a threshold value.

18. The power supply voltage management method of claim 17, wherein the temperature sensing control circuit comprises a PTC device to sense the temperature of the linear regulator, and the threshold value is a temperature at which the PTC device trips.

19. The power supply voltage management method of claim 16, further comprising a step of sustaining the series connection alter switching the first lighting component and a second lighting component to be in series connection.

20. The power supply voltage management method of claim 16, wherein the first lighting component is the same as the second lighting component, and the second voltage is two times the first voltage.
